(19) United States
(12) Patent Application Publication
(10) Pub. No.: US 2009/0033926 A1
(43) Pub. Date: Feb. 5, 2009

(54) Device for Calibrating an Image Sensor System in a Motor Vehicle

(76) Inventor: Karsten Haug, Stuttgart (DE)

Correspondence Address: KENYON & KENYON LLP, ONE BROADWAY, NEW YORK, NY, 10004, US

(21) Appl. No.: 11/664,560

(22) PCT Filed: Aug. 26, 2005
(86) PCT No.: PCT/EP05/54217

§ 371 Date: Mar. 11, 2008

(30) Foreign Application Priority Data
Oct. 13, 2004 (DE) 10 2004 049 869.5
Nov. 24, 2004 (DE) 10 2004 056 669.0

(51) Int. Cl. G01J 1/02

(52) U.S. Cl. 356/243.1

(57) ABSTRACT

A device for calibrating an image sensor system in a motor vehicle includes an onboard calibration object situated on engine hood of vehicle. The engine hood is put into a selected position to perform the calibration.

### BACKGROUND OF THE INVENTION

1. Field of the Invention

The present invention relates to a device for calibrating at least one image sensor system connected to a motor vehicle by using at least one calibration object.

2. Description of Related Art

Use of image sensor systems for detecting the vehicle's surroundings has been proposed for motor vehicles. Use of image sensor systems in conjunction with driver assistance systems is planned in particular. For example, it is possible in this way to use image sensor systems for automatic regulation of the distance from a vehicle traveling ahead. To increase the image detection range, use of multiple image sensor systems in one motor vehicle is also being planned, their detection ranges optionally also overlapping at least in part. In particular, the use of stereo cameras composed of two image sensor systems essentially recording the same scene is also provided.

Methods and devices for calibrating image sensor systems in motor vehicles using a calibration object are known. Published German patent document DE 102 29 336.8, for example, describes a device and a method for calibrating an image sensor system using a calibration object and a positional reference sensor. Published European patent document EP 1 120 746 also describes a method for calibrating an image sensor system in a motor vehicle using a calibration object. The calibration object here is connected to the motor vehicle and is aligned with respect to the motor vehicle via a mechanical adjustment device. The calibration is performed with respect to the longitudinal axis of the vehicle. The longitudinal axis can be constructed using symmetrical features on the motor vehicle, in particular the vehicle body. However, owing to manufacturing tolerances, this longitudinal axis does not match the geometric driving axis, which is defined by the bisector of the total toe-in angle of the rear axle. Deviations between the longitudinal axis and the geometric driving axis are not negligible for a measuring image sensor system, in particular when used in driver assistance systems in motor vehicles, because the geometric driving axis defines the direction of travel when driving straight ahead, regardless of the position of the longitudinal axis. Published European patent document EP 1 120 746 does not contain any hints for determining the alignment of an image sensor system with regard to the geometric driving axis of the vehicle for calibration of an image sensor system.

Published German patent document DE 102 46 066 also describes a method for calibrating at least one image sensor system situated in and/or on a motor vehicle, using at least one calibration object, the image sensor system generating a first piece of image information of the calibration object, preferably in the form of at least one image data record, the motor vehicle assuming a first position with regard to the calibration object; the image sensor system then generates a second piece of image information of the calibration object, preferably in the form of at least one image data record, the motor vehicle assuming a second position with regard to the calibration object; the change in position of the motor vehicle with regard to the calibration object then taking place from the first position to the second position through movement of the vehicle; and then the alignment of the image sensor system with regard to the geometric driving axis of the motor vehicle is determined at least from the first and second pieces of image information thus generated for the calibration object. This German patent document also describes a device for calibrating at least one image sensor system which is in and/or on a motor vehicle, having at least one calibration object and at least one analyzer unit which analyzes the image information of the at least one image sensor system; the analyzer unit also has means to permit a determination of the alignment of the image sensor system with regard to the geometric driving axis of the motor vehicle at least from a first and a second piece of image information of the calibration object, the image information preferably being in the form of at least one image data record. In these known methods, the calibration object is located outside of the vehicle, e.g., in a repair shop, and must be approached specially for the calibration procedure.

Published Japanese patent document JP 06-215134 describes a method for image detection using a vehicle-mounted television camera, wherein the television camera detects a portion of the vehicle, in particular the edge of the engine hood, and the image position is corrected as a function of the position of the edge of the engine hood. In principle, calibration of an image sensor system using onboard means is therefore possible, so that a separate trip to the service station is no longer necessary to perform a calibration using the calibration objects available there. However, because of modern vehicle body shapes, there are considerable problems in practice because the engine hoods conventionally used today often do not have any pronounced edges. Furthermore, the engine hoods and/or their edges no longer have any defined 3D structures, so no depth information is available for an image sensor system. Therefore, calibration based on edges is no longer possible. Known image sensor systems are therefore usually designed in such a way that no vehicle components are visible in the detection range of the image sensor while driving.

### A BRIEF SUMMARY OF THE INVENTION

The present invention avoids this disadvantage of the conventional systems and permits calibration of an image sensor system using onboard means even in vehicles having a modern vehicle design.

In accordance with the present invention, calibration of an image sensor system is made possible on site, i.e., without a trip to a service station, if an onboard calibration object, e.g., one mounted fixedly in the vehicle, is brought into a position at least for the duration of a calibration procedure in such a way that it is detectable by the image sensor of the image sensor system and is within the depth-of-field range of the image sensor.

### BRIEF DESCRIPTION OF THE SEVERAL VIEWS OF THE DRAWINGS

FIG. 1 schematically shows a vehicle having an image sensor system and a calibration object.

FIG. 2 shows a front view of a first exemplary embodiment of a calibration object.

FIG. 3 shows a side view of a second exemplary embodiment of a calibration object.

### DETAILED DESCRIPTION OF THE INVENTION

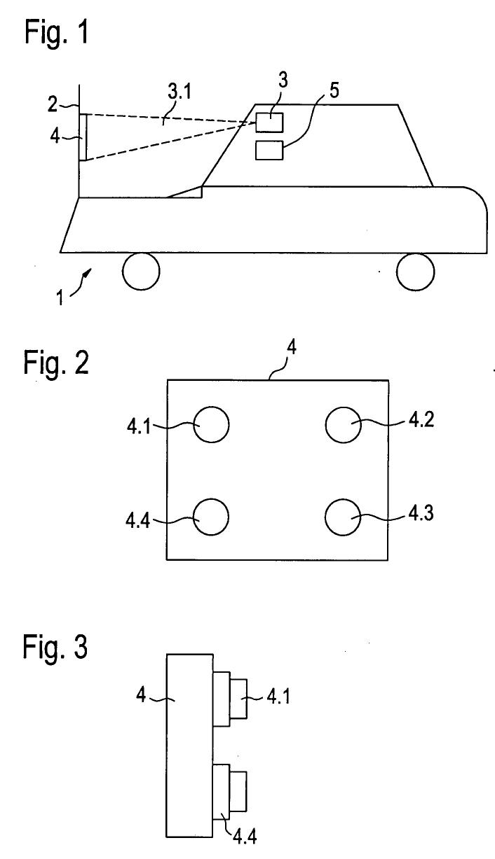

FIG. 1 shows a schematic diagram of a vehicle 1 having an onboard image sensor system 3. In this exemplary embodiment, image sensor system 3 is mounted in vehicle 1, e.g., behind the windshield in the area of the rearview mirror. Detection range 3.1 of image sensor system 3 is aligned in the direction of forward travel of vehicle 1. Image sensor system 3 may be a video sensor, designed as either a CCD camera or a CMOS camera, for example. Image sensor system 3 may be a component of a driver assistance system, which supports the driver of vehicle 1 in driving vehicle 1 by permitting automatic lane guidance of vehicle 1, for example. To do so, image sensor system 3 detects image data from the surroundings of vehicle 1, the data originating from detection range 3.1 of image sensor system 3. Very high demands are made of the accuracy of image sensor system 3. These demands are feasible virtually only by regular calibration of image sensor system 3, which is to be performed when the vehicle is manufactured or repaired and as part of regular maintenance intervals. Special calibration objects or calibration targets have been required for calibrating image sensor system 3 in the past; these calibration objects are usually placed in front of the vehicle when it is in the repair shop and must be aligned with it accurately. Accurate alignment with the vehicle is tedious and requires special instrumental technology. There have already been proposals for performing the calibration of an onboard image sensor system autonomously using onboard means and using the edge of the engine hood of the vehicle detected by the image sensor system as the calibration object, but in practice this approach has failed due to the fact that the engine hoods of vehicles no longer have any straight edges suitable for use as calibration objects, due to modern vehicle design.

The present invention permits autonomous calibration (i.e., independently of the service station) of an onboard image sensor system using onboard means by providing an onboard calibration object, using which the image sensor system of the vehicle is calibratable. The calibration object is brought into active visual connection with the image sensor of the image sensor system at least for the duration of a calibration procedure. This is accomplished in a particularly simple and advantageous manner by providing a calibration object 4 on the inside of engine hood 2 of vehicle 1, as illustrated in FIG. 1, in such a way that after raising engine hood 2, the calibration object is within detection range 3.1 of image sensor system 3 and in the depth-of-field range of the image sensor of image detection system 3. FIG. 1 shows engine hood 2 in the raised position. Due to the location of calibration object 4 on the inside of engine hood 2, no external calibration object is necessary. This yields cost advantages in the manufacture of the vehicle, in the repair shop, and also for the owner of the vehicle because image sensor system 3 may be calibrated for the first time without the use of complex external instrument technology and may be recalibrated at any time, if necessary. Since engine hood 2 is aligned accurately with vehicle 1 by design, calibration object 4 mounted on the inside of engine hood 2 already has a precise reference position which facilitates good calibration of image sensor system 3. Since engine hood 2 and the crossbars of vehicle 1 supporting the engine function as a vehicle reference system for the driver for his visual perception during normal driving operation, image sensor system 3 is also calibrated in good correlation with this reference system. Precise alignment of engine hood 2 may also be checked advantageously by monitoring the gap dimensions or by additionally provided reference marks.

Since calibration object 4 is mounted on the inside of engine hood 2, this does not interfere with the design of vehicle 1. This advantageously also yields more design options for optimum design of reference features 4.1, 4.2, 4.3, 4.4 situated on calibration object 4, to be discussed in greater detail below. Due to an essentially vertical position of engine hood 2 when raised for the calibration procedure, a much better active visual connection between calibration object 4 and image sensor system 3 to be calibrated is obtained than with a device with which image sensor system 3 must be aligned with respect to the edge of a closed engine hood 2.

For performing the calibration procedure, engine hood 2 may be opened and brought into one or more defined positions. An almost ideal calibration position is reached when engine hood 2, which is raised at the front, is positioned essentially vertically. If vehicle 1 is equipped with final control elements for an adjustment of engine hood 2, which has been discussed in conjunction with improved pedestrian protection, then these final control elements may be used expediently for the adjustment of engine hood 2 into a calibration position. In the case of vehicles having a very short front end, it may prove expedient to design engine hood 2, which carries calibration object 4, to also be displaceable in the longitudinal direction of the vehicle. In this case, engine hood 2 is additionally shifted in the direction of the longitudinal axis of vehicle 1 either before or after being raised in order to increase the distance of calibration object 4 from image sensor system 3. This may be necessary to position calibration object 4 optimally in the depth-of-field range of image sensor 3. In another example embodiment of the present invention, the engine hood may be mounted on the vehicle in such a way that it may be raised beyond the front of the vehicle at least for performing the calibration procedure. In this way, the calibration object mounted on the engine hood may still be brought reliably into the depth-of-field range of the image sensor.

Two example embodiments of calibration objects 4 are described below with reference to FIGS. 2 and 3. FIG. 2 shows a first example embodiment in a front view. Calibration object 4 here is designed as an essentially flat carrier unit. Four reference features 4.1, 4.2, 4.3, 4.4 are indicated in FIG. 2 and are situated on calibration object 4. For reliable detection of reference features 4.1, 4.2, 4.3, 4.4, they have an easily recognizable geometric structure. They may be formed as circular areas, as depicted in FIG. 2. Reference features 4.1, 4.2, 4.3, 4.4 advantageously have a good contrast with their surroundings. In addition, reference features 4.1, 4.2, 4.3, 4.4 may also be designed to be actively luminous or as retro-reflecting marks. Reference features 4.1, 4.2, 4.3, 4.4 are advantageously designed to permit simple automatic detection in the images of image sensor system 3. Reference features 4.1, 4.2, 4.3, 4.4 depicted in FIG. 2 are circular and designed to be diffusely reflecting optically. They have a diameter selected as a function of the imaging scale of image sensor system 3. Reference features 4.1, 4.2, 4.3, 4.4 are differentiated automatically by the fact that at least one reference feature 4.1, 4.2, 4.3, 4.4 carries a code detectable by image sensor system 3 and/or reference features 4.1, 4.2, 4.3, 4.4 are arranged in groups of a defined geometry.

The detectability of reference feature is facilitated by the measure whereby at least one light source 5 is used for illuminating reference features 4.1, 4.2, 4.3, 4.4. In one example embodiment of the present invention, the calibration object itself may be equipped with a light source, which is also supplied with power by the battery of the vehicle, for example. In particular, at least one light source 5 situated near the lens of image sensor system 3, illuminating the calibration object, facilitates the detectability of retro-reflecting reference features.

Calibration object 4 together with its reference features 4.1, 4.2, 4.3, 4.4 may also advantageously be designed as an imprint on the inside of engine hood 2, e.g., on an insulation mat provided there.

In another example embodiment, reference features 4.1, 4.2, 4.3, 4.4 are designed three-dimensionally, e.g., in the manner of a plunger, to permit three-dimensional calibration of image sensor system 3. This is apparent from FIG. 3, which shows a side view of a calibration object 4. Two reference features 4.1 and 4.4 situated on calibration object 4 are designed in gradations protruding out of the surface of calibration object 4. In an example embodiment, light in the spectrum of infrared light is emitted by a light source 5. This prevents any impairment of the light conditions for people at the measurement site and/or takes into account infrared-sensitive image sensors. If reference features 4.1, 4.2, 4.3, 4.4 are also situated with a spatial offset on calibration object 4, as depicted in FIG. 3 with regard to image sensor system 3, then the analysis is simplified in comparison with a planar arrangement of reference features 4.1, 4.2, 4.3, 4.4, and the measurement results are even more reliable.

For the case in which engine hood 2 cannot be positioned entirely in a vertical position for design reasons, calibration object 4 may advantageously also be connected to the engine hood by a hinge connection. This hinge connection allows calibration object 4 to hang down freely after engine hood 2 is opened in such a way that the calibration object is optimally situated in detection range 3.1 of image sensor system 3. If the longitudinal axis of the engine hood does not match the longitudinal axis of the vehicle, then in an advantageous embodiment of the present invention, a calibration object 4 may also be designed to be adjustable with regard to its position in relation to engine hood 2 so that it is easily adjustable with respect to image sensor system 3.

The present invention has been explained above on the basis of exemplary embodiments in which an image sensor system 3 aligned with the direction of observation in the direction of travel of the vehicle detects a calibration object 4 located on engine hood 2 of the vehicle. Devices permitting calibration of sideways-looking or backward-looking image sensor systems 3 are of course also within the scope of the present invention. In these example embodiments, calibration objects 4 are advantageously situated on the trunk lid and/or doors of the vehicle. By opening doors and/or the trunk lid, calibration objects may easily be brought into the detection range of image sensor system 3.

1-15. (canceled)

16. A device for calibrating an image sensor system in a motor vehicle, comprising:
a calibration object provided on a portion of the motor vehicle.

17. The device as recited in claim 16, wherein the calibration object is configured to be brought into the field of view of the image sensor system for the duration of a calibration procedure.

18. The device as recited in claim 17, wherein the calibration object is provided on an engine hood of the vehicle.

19. The device as recited in claim 18, wherein the calibration object is positioned on an inside of the engine hood.

20. The device as recited in claim 19, wherein the calibration object is configured as an imprint on an insulation mat in the engine hood.

21. The device as recited in claim 19, wherein the calibration object includes at least one reference feature.

22. The device as recited in claim 21, wherein the at least one reference feature has a three-dimensional profile.

23. The device as recited in claim 18, wherein the engine hood is adjustable to provide at least one calibration position for the calibration object.

24. The device as recited in claim 23, wherein the engine hood having the calibration object is coupled to the front of the vehicle.

25. The device as recited in claim 23, wherein the engine hood having the calibration object is displaceable in the longitudinal direction of the vehicle.

26. The device as recited in claim 23, wherein the calibration object is connected by an articulated connection to the engine hood.

27. The device as recited in claim 17, wherein the calibration object is configured such that the position of the calibration object relative to the vehicle is adjustable.

28. The device as recited in claim 17, wherein the calibration object is situated on a door of the vehicle.

29. The device as recited in claim 17, wherein the calibration object is situated on a trunk lid of the vehicle.

30. The device as recited in claim 17, further comprising:
a light source for illuminating the calibration object.
